(19) United States
(12) Patent Application Publication
(10) Pub. No.: US 2024/0011694 A1
(43) Pub. Date: Jan. 11, 2024

(54) Ice Sleeve, Method of Manufacturing, Method of Filling, Kit

(71) Applicant: Elizabeth Dahnken, Fayetteville, AR (US)

(72) Inventor: Elizabeth Dahnken, Fayetteville, AR (US)

(21) Appl. No.: 18/473,266

(22) Filed: Sep. 24, 2023

Related U.S. Application Data
(63) Continuation-in-part of application No. 17/090,887, filed on Nov. 5, 2020, now abandoned.
Application No. 17/090,887 is a continuation-in-part of application No. 16/450,979, filed on Jun. 24, 2019, now abandoned.
(60) Provisional application No. 62/931,214, filed on Nov. 5, 2019.
(60) Provisional application No. 62/689,132, filed on Jun. 23, 2018.

(51) Int. Cl. F25D 3/08; B32B 5/26; B32B 5/02; B65B 1/02; B65B 1/04; B65D 81/38

(52) U.S. Cl. CPC F25D 3/08; B32B 5/26; B32B 5/02; B65B 1/02; B65B 1/04; B65D 81/3897; B32B 2307/302; B32B 2439/46; B32B 2307/7265; B32B 2262/0215; B32B 2262/0261; B32B 2262/0292

(57) ABSTRACT

The present application is directed to a reusable, sealable pouch to hold ice, which is used in food coolers and other applications. Also described herein in method of manufacturing the pouch and a system of the pouch and a cooler.

### CROSS-REFERENCE TO RELATED APPLICATIONS

The present non-provisional application is related to and claims benefit of and priority to U.S. Provisional Patent Application Ser. No. 62/689,132 filed Jun. 23, 2018 and 62/931,214 filed Nov. 5, 2019 and U.S. Non-Provisional Patent Application Ser. No. 16/450,979 filed Jun. 24, 2019 and Ser. No. 17/090,887 filed Nov. 5, 2020, all of which are incorporated by reference in their entirety. The specification of the present application contains the amendments made to the specification in the '887 application. If any conflict arises between the disclosure in this utility application and those in the related prior provisional and non-provisional applications, the disclosure in this utility application shall govern.

### BACKGROUND

### 1. Technical Field

This application is directed to, among other things, a reusable sealable pouch for holding ice and protecting the ice's meltwater and condensation away from cooler contents.

### 2. Background

Currently there are a number of freezable solutions like ice packs for keeping items cold in a cooler or container used for food or other items. Some of these solutions attempt to keep items cold without the use of actual ice or ice cubes. Once unfrozen or melted, there is no option to replenish the source of cold as needed without being returned to a cold location such as a freezer or refrigerator for several hours.

Other solutions attempt to provide a container for ice like an ice bucket from a hotel room. Still other solutions seek to create a barrier between food or items in a cooler and the melted ice pools at the bottom of the cooler or other container. None of these solutions can adequately address the problems that the embodiments described herein solve.

### SUMMARY

Trying to address the need for continuous cooling on the go with access to ice but without access to a freezer, none of the other mentioned solutions provide a workable solution. Filling a cooler with a bag of ice has the problem of the bag leaking and/or condensation forming outside of the bag, undesirably soaking the contents of the cooler. As discussed above, freezer-design solutions like ice packs need to constantly be put in a freezer and cannot be recooled/replenished without access to the freezer. A fixed container like an ice bucket cannot flexibly adapt to different sizes and configurations of cooler, and likely still has the same condensation issues. A flexible insulated cooler filled with ice would not transfer its cold temperatures to an outer cooler. A non-waterproof bag or pouch holding ice would leak its meltwater contents within the cooler. Ice is often readily available to consumers even though their home freezer may not be convenient. The reusable sealable pouch for holding ice discussed herein is an improvement to the cooler industry offerings on the market that keep food or other items cooler and drier in food coolers.

It would be desirable to have a waterproof or water resistant pouch, that may be either independent or affixed to the inside of a cooler or a container, made of but not limited to nylon, polyester, PVC, or any other material that is inherently waterproof or using a water-resistant or water-repellent application which/that can hold ice cubes or water, or anything else cold, for the purposes or keeping food cold and dry in a cooler or ice chest, and this material can maintain thermal temperatures suitable to its purpose of retaining cold and/or slowly emitting cold, and/or be used to keep anything else cold and/or dry for the purposes of physical-related wellness, including but not limited to reducing inflammation, swelling and/or pain in the body, or in any other capacity as needed. Furthermore, it would also be desirable to have a waterproof or water resistant/water repellent pouch, pocket or sack holding ice or water that has a closure by way of zipper, buttons, snaps and/or any other method used to couple and uncouple one or more pieces of fabric, for the purposes of containing ice or water, or any material in a solid or liquid state, without leakage, and to also dispose of ice or water, or any material in a solid or liquid state as needed. Still further, it would be desirable to have one or more seams in the pouch, by way of stitching, sewing or welding, or any other method used to couple and/or uncouple two pieces of material, for the purpose of guiding the cubes or liquid to evenly disperse throughout the pouch, or to have no channel. Still further, it would be desirable to absorb moisture on the exterior layer resulting from condensation. Therefore, there currently exists a need in the industry for a waterproof or water-resistant pouch that is reusable, resealable, and that can be frozen, unfrozen and refrozen, to be used to hold ice cubes and/or water, or any other liquid or substance for the purpose of keeping food or other items cold and dry in a food cooler or ice chest, or any other container in which ice is traditionally poured, and for the additional purpose of, but not limited to, the use of a pouch that is reusable and re-freezable and used for the purposes of physical wellness.

It is still further an object to create an example embodiment that advantageously fills the aforementioned deficiencies by providing a reusable, sealable pouch holding ice and/or water, or any other substance intending to keep items both cold and dry in a cooler.

Disclosed is a waterproof container, pouch, bag or sack for ice and/or water, which is made up of the following components: a waterproof and/or water-resistant material; an opening to allow the ice and/or water or other substance to enter, a closure to seal in the ice and/or water or other liquid; and a device that also allows to empty the contents of the pouch; and a method to channel the contents in a way that evenly distributes the contents in the container. The various pouches herein can also be referred to as ice sleeves or bags or ice blankets or sack or container. These components are connected as follows: the ice, water, and/or other liquid enters the opening of the pouch and is channeled throughout by a method to distribute the contents evenly; the pouch is sealed in for the purpose of being placed into a cooler or any container where cooling is needed; the ice and/or liquid can then be removed as needed, from the pouch via the same opening or via any other location or method.

An example device may also have one or more of the following snaps, buttons or any other method used to fasten the pouch for secondary closure, after primary closure or sealing, for added safeguarding of liquids in the pouch, sack or container. It may also have seams, stitching or welding to create channels guiding the ice or water into the bag for purposes of even dispersal. The device may also use a waterproof/liquid proof or water/liquid repellent coating and/or laminating, including but not limited to Filium®, Aquagard®, or WaterSeal®.

An example device may also have an additional layer of material, or multiple layers, for purposes of temperature regulation, facilitating condensation, absorbing condensation, or extending or increasing duration of time that ice, or any other frozen mixture, uses to melt or return to liquid state. Additionally or alternatively, an example device may also be any other shape than a rectangle, as well as any other size. An example device may also have a different opening/closure than a zipper, snaps, buttons or anything used to couple and uncouple layers of material together. The device may also contain stitching, seams, threading or welding to create channels to evenly disperse the ice, water, or any other frozen material or liquid material, meaning that the ice or liquid could enter the device without channels for even dispersion. The device may also be constructed in or affixed to the interior of a container.

Another example embodiment is unique when compared with other known devices and solutions because it provides: ample space to fit 10-25 lbs. of ice cubes or a similar volume of liquid, while it also can be modified for the use of less ice as needed; channels to guide the cubes or liquid for even dispersion; and a large opening to fill and empty with ease and efficiency; the materials stated provide a soft, flexible casing for the ice. It is also unique as it can fit most sizes of hard- or soft-shell coolers. It is also unique in its ability to facilitate and/or absorb moisture on the exterior. It is also unique in its ability to be constructed in or affixed to the interior of another container. It is also unique in its optional middle layer containing a bead, clay or gel substance, made of non-toxic or toxic materials, that facilitate a slower transfer of cold from the interior of the pouch to the interior of the cooler, thus allowing the pouch to retain cold for a longer time period.

The disclosed device is unique in that it is structurally different from other known devices or solutions and used for a different purpose. More specifically, the device is unique due to the presence of: its casing, which allows for ice to be inserted and removed, making it reusable and refillable; it contains channels that guide the ice cubes for even dispersion; it has a large and/or funnel shaped opening that allows for easy filling and emptying of ice or liquid. The device is also unique because of its opening; the opening seals the device to prevent leakage and can be reopened. Also unique is the casing. It is flexible and waterproof, using the materials stated, making it adaptive to multiple sizes of both soft-shell and hard-shell coolers.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The reusable sealable pouch holding ice for food coolers may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

FIG. 1 is a perspective view of an exemplary embodiment that illustrates a roll-top closure and channels.

FIG. 2A is a cross-sectional view of a second exemplary embodiment that illustrates an extra-large opening and coupled materials that define channels.

FIG. 2B is a cross sectional view of the second exemplary embodiment modified with a valve.

FIG. 3 is an exploded view of a third exemplary embodiment that illustrates two material layers in a device.

FIG. 4 is a cross-sectional view of a fourth exemplary embodiment that illustrates a device with coupled materials creating two channels for guiding the ice for even dispersion and a smaller opening than the second embodiment.

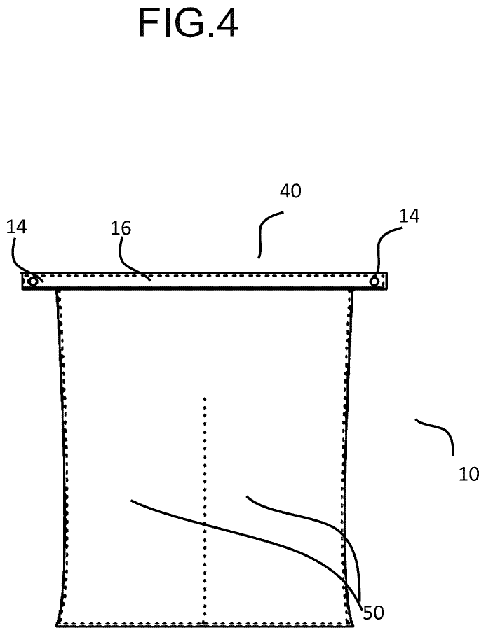

FIG. 5 is a perspective view of a fifth embodiment showing a device constructed in or affixed to the interior of a container.

FIG. 6 illustrates a close up view of a sixth exemplary embodiment highlighting loading ice into a device including a zippered closure, and channels guiding the ice for even dispersion.

FIG. 7 is a perspective view of an exemplary device, which can correspond to several embodiments, being placed into a cooler.

FIG. 8 is a perspective view of a seventh embodiment including a two-layer bag with a waterproof interior and a moisture-wicking exterior, wider opening, a roll-top primary closure, a hook-and-loop fastener secondary closure for holding the roll-top closed, an internal silicone seal to define channels to guide the ice, and a flattish-bottom structure for helping the bag to stand. For the purpose of this specification, “wicking” and “absorbing” moisture mean the same thing. It is believed that the wicking works by attracting and dispersing the water. The wicking surface can be hydrophilic and/or with enough surface roughness to cause water not to bead up on the surface. The wicking can be done by a flocking material.

FIG. 9 is a perspective view of an eighth embodiment including a two-layer pouch with a waterproof interior and a moisture-wicking exterior, a roll-top closure with snaps on the side to close and keep the pouch flat. This pouch has welded sides for a waterproof seal. It also has a hook and elastic to adjust the size of the bag, based on the volume of contents within.

FIG. 10 is a perspective view of a ninth embodiment including a waterproof zipper seal installed on the long part of the pouch. This extra-wide opening allows for easy pouring of ice into the interior. This is a two-layer construction of nylon and waterproof Gore-tex® blend with a waterproof coating protecting against leakage. Gore-tex® material helps reduce condensation due to its cell membrane structure that prevents water molecules from passing through. This also has a channel created internally to aid in evenly distributed ice.

FIG. 11 is a perspective view of a tenth embodiment including a pouch constructed of waterproof nylon 70D (70 Denier) with a roll-top buckle closure for a waterproof seal. One channel is in the interior to help ice distribute evenly. Hook-and-loop fastener system color-codes to provide instruction to the user for creating an adjustable-sized bag, to allow for easy portability between smaller and larger coolers. For example, in FIG. 11, the hook-and-loop regions most distal to the opening are color coded similarly to instruct the user that these areas connect, folding the pouch in half.

FIG. 12 is a perspective view of a tenth embodiment illustrating a pouch constructed from waterproof nylon 70D (70 Denier) with a combination of waterproof zipper that rolls down, and then snaps on either side to keep the pouch flat. There is an internal channel down the middle to assist the even distribution of ice, created by sewn waterproof seams.

FIG. 13 illustrates a perspective view of a twelfth embodiment showing a funnel that extends from a foldable position inside of the pouch to an unfolded position outside of the pouch. The funnel is used for assisting with pouring ice into the pouch.

FIG. 14 is a chart of example experiments performed by the inventor.

### DETAILED DESCRIPTION

The present embodiments are directed to reusable sealable pouches holding ice for food coolers. Coolers can have a range of sizes, shapes and types. An example classic hardshell cooler is something like an Igloo(R) brand cooler. An example of a soft-shell cooler is something like a Yeti(R) brand cooler.

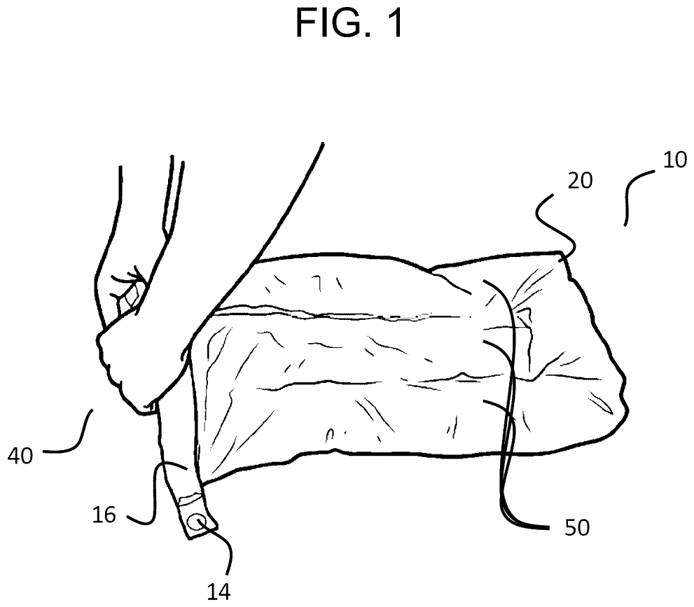

As shown in FIG. 1, the device 10 is made of the following components: a bag, pouch or sack 20 that is made of but not limited to: any flexible, woven or non-woven, material 25, such as but not limited to, polyester, nylon, acrylic, microfiber, vinyl, wool, wool gabardine, cotton, silicone, rubber; any material that is or is not inherently waterproof/liquid proof or water/liquid repellent, on one or both sides, including but not limited to: nylon, polyester, tarpaulin, rubber, latex, microfiber, acrylic, silicone, Hypalon®, Neoprene®, Cordura®, Gore-tex®, pyridinium or melamine complexes, polyurethane, acrylic, fluorine or Teflon. Any of these materials may also use a waterproof/liquid proof or water/liquid repellent coating and/or laminating, including but not limited to Filium®, Aquagard®, or WaterSeal®. The thickness of the layers should be designed for the thermal conductivity needed.

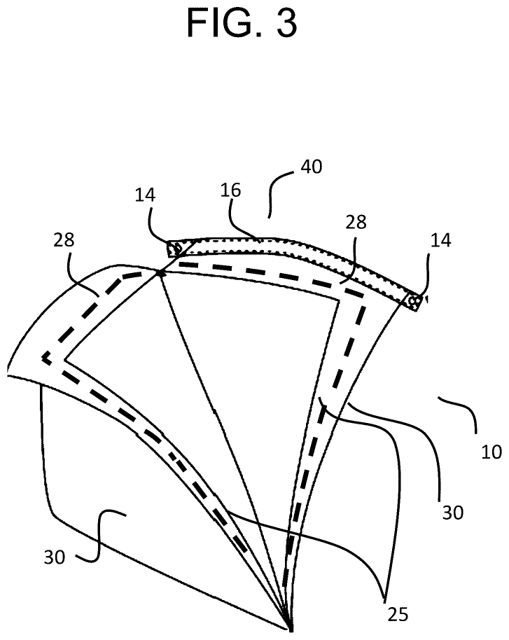

As shown in FIG. 3, the device 10 can also have an additional layer of material or multiple layers, for purposes of retaining water, ice or liquids; temperature regulation, facilitating and/or absorbing condensation, or extending or increasing duration of time that ice, or any other frozen mixture, uses to melt or return to liquid state. An additional optional or alternative cold store holding layer 28 (shown by a dotted line) can be used to slow the temperature transmission. The device 10 is also in additional shapes besides a rectangle, as well as any other size. The device 10 also has a different opening/closure other than a zipper 12, snaps 14, buttons or anything used to couple and uncouple layers of material together. A layer could be a coating, surface treatment or a standalone surface.

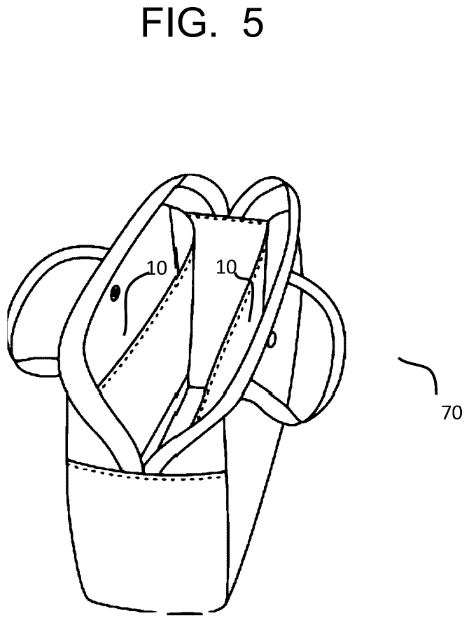

The device 10 (closure not shown), as shown in FIG. 5, may be affixed to or constructed in the interior of a container 70, with the purpose of facilitating a cold environment in the container while containing the ice or frozen liquid, or liquid, separately from the contents of the container.

The device has one or more of the following: snaps 14, buttons or any other method used to fasten the pouch for secondary closure, after primary closure or sealing, for added safeguarding of liquids in the pouch, sack or container. It does or does not have seams, stitching, welding or any other method that couples and/or uncouples two or more pieces of material together to create channels 50 guiding the ice 60 or water into the bag 20 for purposes of even dispersion.

The full device also may include channels 50. Channels can vary from 0 to infinite, intended to guide the cubes or liquids through the bag for even distribution.

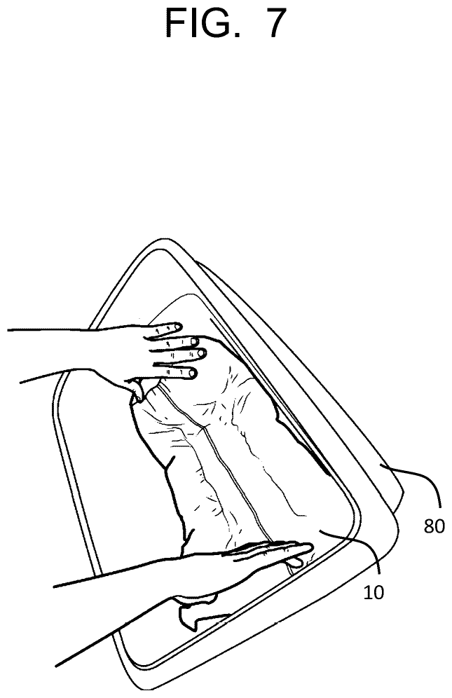

As shown in FIG. 7, the device going into a cooler 80 is an example of its use. It can be used in a variety of sizes of coolers, due to its flexibility and ability to be compressed in size. The bag, filled with ice or liquid, is laid on top of the food or other items, allowing the cold to travel downward while keeping the food/items dry from ice melt.

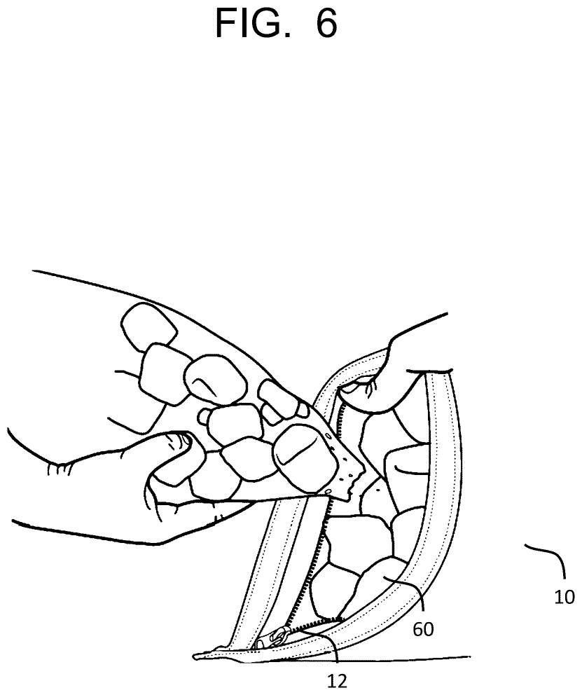

FIG. 6 illustrates the ice 60 being poured out of a bag and into the device. The amount of ice or liquids going into the device can be adjusted as needed, and the device can be compressed into a smaller size if needed.

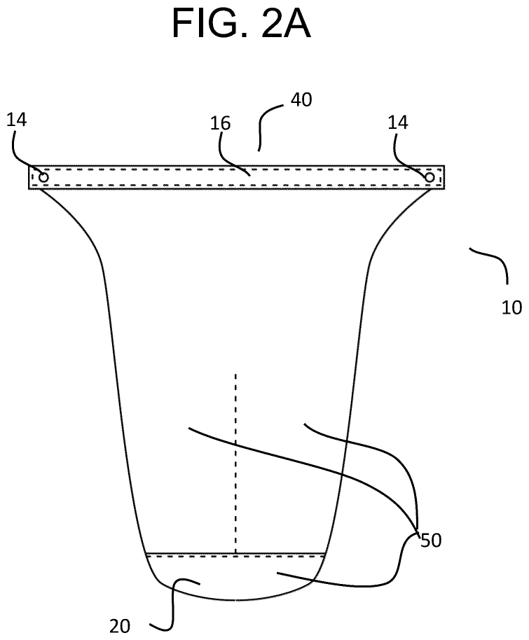

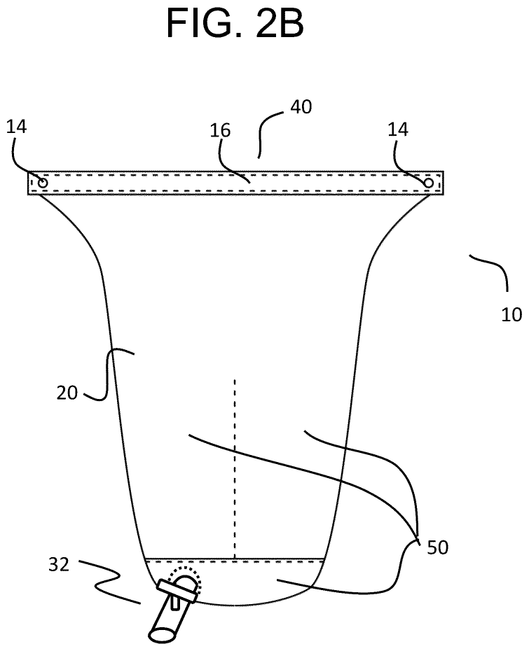

The opening 40 of the device is large for ease of filling. As shown in FIG. 2A, the opening may be funnel shaped, widening at the opening to guide the entry of ice, frozen liquid, or liquid. The device can be closed by one of more of the following methods: waterproof zipper 12, roll top closure 16 in which the two pieces of material are pressed together and rolled downward 3 or more times, then fastened by buttons, magnets and/or snaps 14 (as shown in FIG. 1), or any other method to seal/unseal the device to contain the ice or liquids.

FIG. 2A shows a variation of the device of FIG. 2A with 1 coupled area and 2 similarly sized channels shown. The device can also have zero channels (i.e., a single interior volume). The device can also have more than one channel 50. The channel can be created through stitching, welding or any other method used to couple and uncouple the material together to create channels guiding the ice or liquids through the bag, for even dispersion.

In a pouch designed to be filled with wet materials and/or found in wet environments, mold prevention is a consideration. An example embodiment of the pouch is flexible and deformable and allows the pouch to be turned inside out for cleaning and drying. The flexibility of the pouch enables it to do this, giving its owner access to its interior for cleaning. Additionally or alternatively, the exemplary embodiment can have a sealable spout or valve (“valve”) that allows air or fluid to flow through it. The valve remains sealed during use to prevent water leakage from the melted ice into the cooler. FIG. 2B shows a valve 32 that is operable to evacuate the liquid from inside the ice reservoir after use. To prevent mold buildup inside the ice reservoir, an accessible valve 32 can drain the water or allow airflow into the ice reservoir when evacuating the contents from the main opening. The large opening to the ice reservoir allows the user to pat dry the interior of the ice reservoir, removing the environmental conditions for mold growth. The valve 32 can be attached and waterproof sealed to the pouch layers using a variety of methods. Preferably, the valve 32 has insulating characteristics so as not to create its own source of water condensation during pouch use in a cooler. Among other types, plastic or ceramic valves could work for this purpose. The exemplary valve 32 has at least the options to turn on and off flow through the valve. For example, mechanisms for opening the valve 32 could be a detent-based system where a button must be pressed to allow flow, or it could be a simple valve-based system like those used to control the flow of a hose spigot or a propane grill. In a different exemplary embodiment not shown, the valve control mechanism is located interior to the pouch. This design, while making the valve control mechanism harder to reach, makes it less likely to be bumped by the food in the cooler. In certain environments where pressure or the lack thereof is an issue, a valve that prevents liquid flow yet allows vapor pressure regulation could also be used. This type of valve could be controlled or permanently open based on the application. In some example embodiments, the pouch material itself may allow vapor pressure regulation while still providing a waterproof sealed reservoir and this additional valve may not be needed.

One of the features of some of the exemplary embodiments herein is a flexible pouch that can be applied to lay flat or molded after being filled with ice in other desirable shapes in a cooler based on its available space. To achieve this flexibility, the internal layers of the pouch must individually have flexibility and not be bound to other layers in a way that removes this flexibility on a large scale.

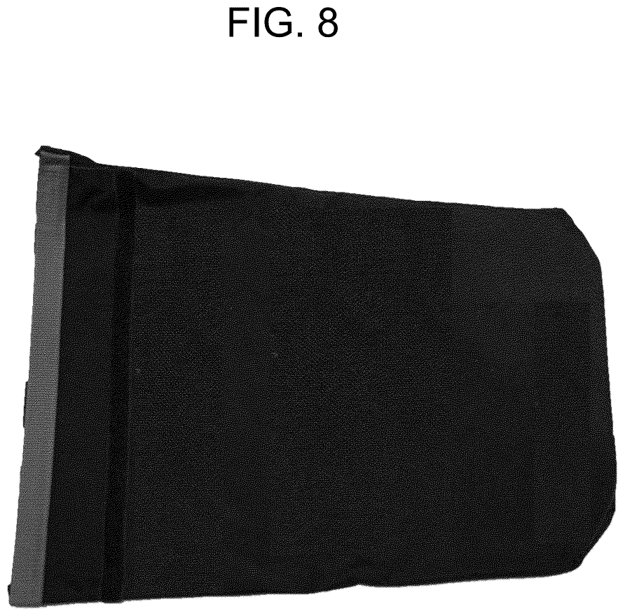

FIG. 8 is a photo of an example waterproof pouch made from Cordura® Classic fabric, coated with water repellant and having 500 Denier (500D) filament content, with a TPU coating on the interior. The exterior Cordura® Classic 500D helps absorb condensation, keeping the bag feeling dry. Although Cordura® Classic 500D is used here in this example embodiment, other materials and thicknesses could work and still achieve the water proofing, thermal conductivity and moisture wicking benefits of this embodiment.

In FIG. 8, the opening is widened at the top for easy pouring of ice (or liquids) into the bag. The primary closure is roll-top, using hook-and-loop fasteners as the seal once the opening is rolled shut. Optionally, a waterproof zipper or thickened regions in the opening can be used to increase the sealing ability of the closure. The widened opening can have pleats that fold inward for the opening to resume the rectangular width of the rest of the pouch.

The example embodiment of FIG. 8 has flat-bottom structure for helping the pouch stand upright. Additionally, it has an internal silicone seal through the center to define channels that help guide and distribute the ice evenly.

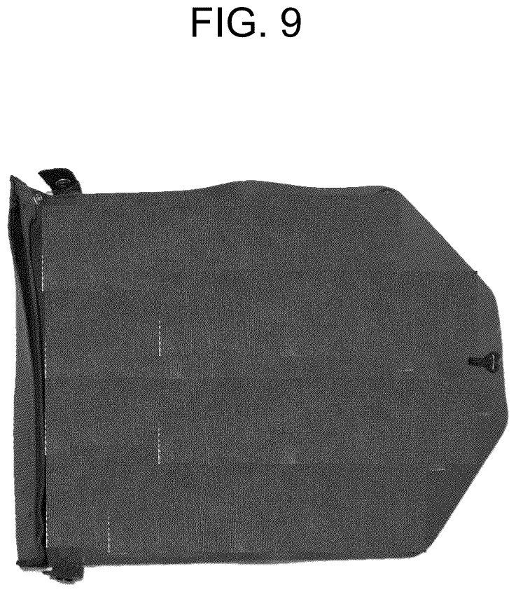

FIG. 9 illustrates an example embodiment of a waterproof pouch made from Cordura® Classic 1000D (1000 Denier) with TPU coating on the interior. Similar to FIG. 8, in FIG. 9 the exterior Cordura® helps absorb condensation, keeping the bag feeling dry. The opening matches the width of the bag but is wide for easy pouring. In FIG. 9, the panels of the pouch are RF (radiofrequency) welded for a waterproof seal. For a Cordura® layer, Cordura® Classic 500D is more pliable than Cordura® Classic 1000D. As discussed later, Cordura® 1000d has poor temperature conductivity, which limits its usefulness in applications where quick cooling is needed.

Additionally, FIG. 9 has a hook and elastic loop (not shown because of its location on the backside of the pouch) on the pouch to adjust the size of the bag, based on the volume of contents within. The loop can be attached to the hook to fold the pouch in half or some other amount. This allows easy portability between small and large coolers. A variation of this is a buckle (e.g., a side release buckle) and strap (e.g., nylon). The strap enables shortening the length of the bag by pulling the strap tight and being held in place by the buckle.

In FIG. 9, the closure is roll-top with snaps on either side to close and keep the pouch flat. This closure can be benefited from an optional waterproof zipper or the equivalent in the opening before rolling.

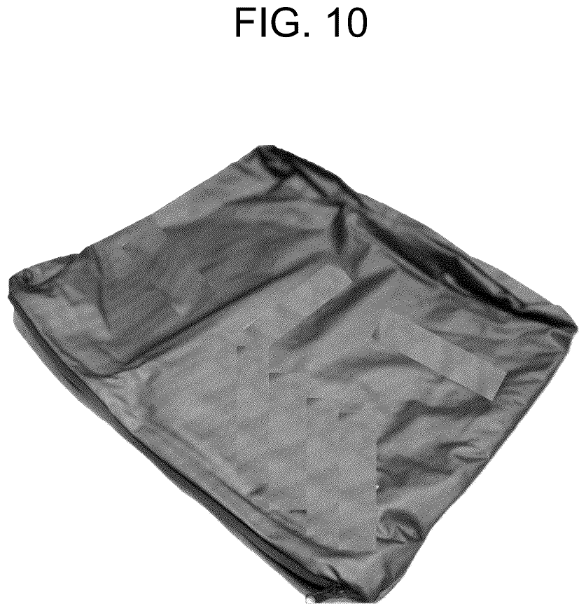

FIG. 10 illustrates a pouch having a waterproof zipper seal installed on the long part of the pouch. This extra-wide opening without the pouch having a flared shape allows for easy pouring of ice into the interior. A single layer of material is used being a blend of nylon and waterproof Gore-tex®, protecting against leakage. Gore-tex® material helps reduce condensation due to its cell membrane structure that prevents water molecules from passing through. Channel is created internally to aid in evenly distributed ice.

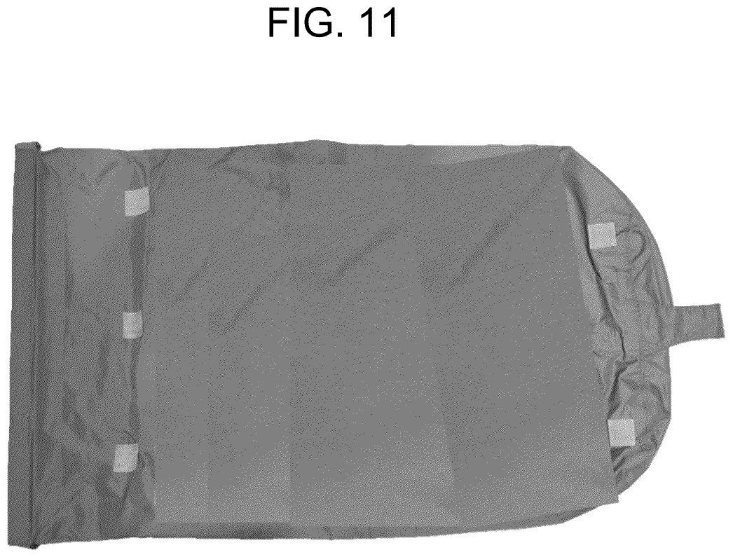

FIG. 11 illustrates a pouch is made from waterproof PU nylon 70D with a roll-top buckle closure for a waterproof seal. One channel is in the interior to help ice distribute evenly. Velcro system color-coordinates the Velcro to create an adjustable-sized bag, to allow for easy portability between smaller and larger coolers.

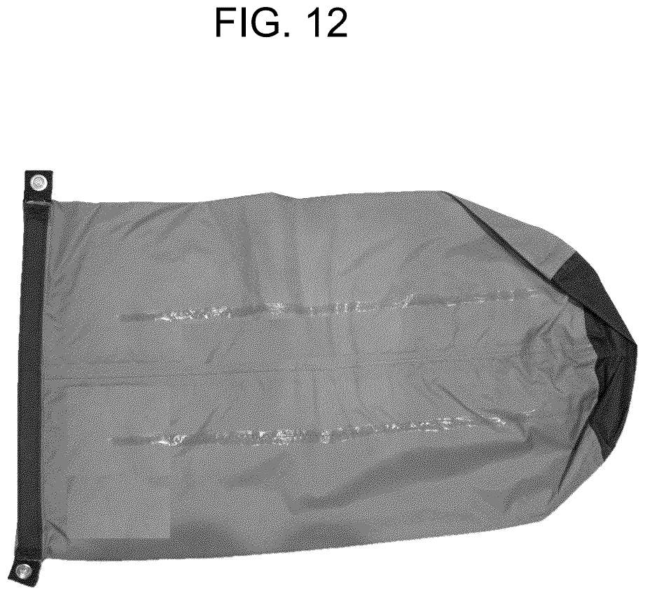

FIG. 12 illustrates a pouch constructed of waterproof Ripstop nylon 70D (70 Denier) lined with a TPU coating. The pouch has a combination of waterproof zipper that rolls down, and then snaps on either side to keep the pouch flat. There is one internal channel in the middle of the pouch to assist the even distribution of ice created by sewn seams that have been waterproofed with a sealing layer on the outside of the pouch. Additionally or alternatively, this could be sealed from the inside of the pouch.

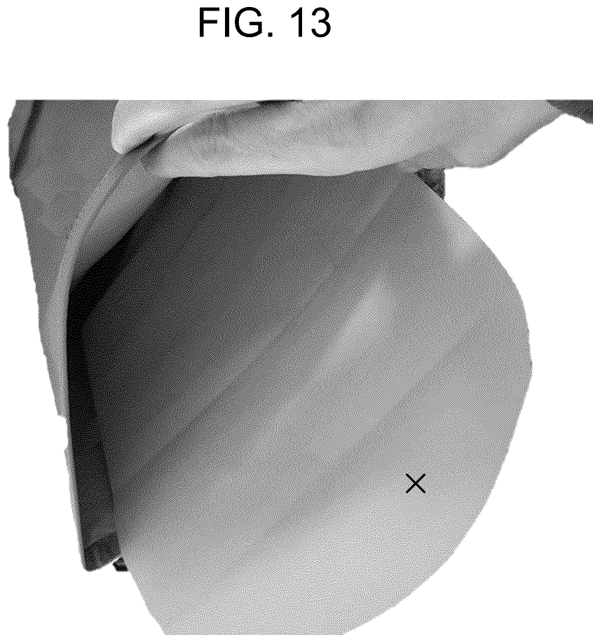

Additionally or alternatively, an example embodiment of the pouch has an internal deflector or funnel structure (collectively referred to as a funnel) to assist with pouring ice into the pouch's opening. FIG. 13 a photo of a hand holding an example embodiment of a PU nylon 70D pouch with a funnel (marked by an X) that extends from a folded position inside the pouch to an unfolded position beyond the pouch to provide a guide to assist ice being poured into the pouch. This funnel type should be strong enough and thick enough to provide resistance to the weight of ice to keep it going in the pouch during an ice pour. Examples of material for this could be a foam. In another embodiment (not shown), a piece of material can be stored in a sleeve or pocket in the inner wall of the pouch and extended out when needed. An optional feature is something that forces compression on the edges of the extending piece to cause it to be concave for additional strength and a shape that catches the ice better during an ice pour.

One funnel option is to have extra fabric inside the opening that is attached or sewn into the pouch that can be used to wrap around and support a bag of ice so that ice is prevented from spilling during the pour into the pouch. A different funnel option is a one that is stored outside of the pouch when the pouch is sealed and can be connected by a piece of fabric or a string.

Additionally or alternatively, an example embodiment has a self-actuated opening that opens upon a user unsealing the pouch. The self-actuated opening relies on an extension material or a spring having at least one default opening position, such as an extended steel bi-stable spring band or nitinol shape memory alloy. This extension material would cause the opening to spring, unfold, actuate, or unroll into an ice loading position. Such a position could be a maximum opening size or a comfortable loading angle. The extension material or spring can be in a protective sleeve that allows movement in the extension direction.

An example closing mechanism for this type of funnel opening is a cinchable elastic drawstring to be used after bunching into the opening the extra fabric. The cinched fabric then tucks back in and rolls down and the other primary and/or secondary sealing mechanisms such the roll top closure, waterproof zipper, hook-and-loop fasteners would then seal the pouch. Nylon is an optional choice for this extra fabric.

Another example embodiment adds additional functional layer(s). For example, a layer could be added external to the ice and internal to the wicking surface that has a cold store that helps to retain cold and slow down the releasing and emanating cold from the ice to the outside of the bag. The design of this layer will somewhat depend on what material is being used for the cold store and how it can be held. For example, clay, beads, cold packs, gels, and other materials now known or later arising, could be used as the cold store provided the pouch remains flexible. In many cases there will be a layer on each side of the cold store to hold it in place. The idea of the cold store is not to replace the ice but to make the temperature transmitted to the cooler contents more evenly. Many off-the-shelf ice packs use toxic materials such as sodium polyacrylate. While the pouch can still function with a toxic cold store such as sodium polyacrylate beads, a non-toxic cold store is preferable when used for temperature management in food applications. Among other materials, water-based beads, clays, and gels, individually or in combination, can function as example cold stores.

FIG. 3 using the dashed lines shows an exemplary three-layer system designed to hold the ice. The first layer 25 is a layer closest to the ice. This layer holds the ice and its meltwater in the ice reservoir defined by layer 25. The next layer 28 is the cold store layer which is designed to hold the cold store in place proximate to the ice. The outer layer 30 is a moisture wicking layer that prevents moisture buildup as a result of the differences in temperature from the outside of the pouch to the environment of the cooler. In some example embodiments, the pouch may have access points (not shown) where the cold store layer 28 can be accessed by the user to clean or replace or top up the cold store.

The purpose of the cold store is not necessarily to freeze the pouch in advance, although possible and easy with this pouch, but to slow down and control the temperature conductivity to help the ice last longer. It is the goal of the applicant that ice can be purchased or found by the user and inserted into and sealed in an example embodiment of a pouch without any access to a freezer.

While using the pouch to store ice and other cold objects is the reason for the design of the pouch, in other environments it may be possible to use the same pouch to emit relative warmth by inserting something warm or hot inside the pouch. The pouch should have the same anti-condensation benefits. For example, the pouch could be filled with hot water and used in a frigid environment like Alaska and avoid icing up on the outside for some period of time.

While ice is the primary material described to be held in an ice reservoir, a person of ordinary skill in the art will understand that other cold materials can be used to have the same function.

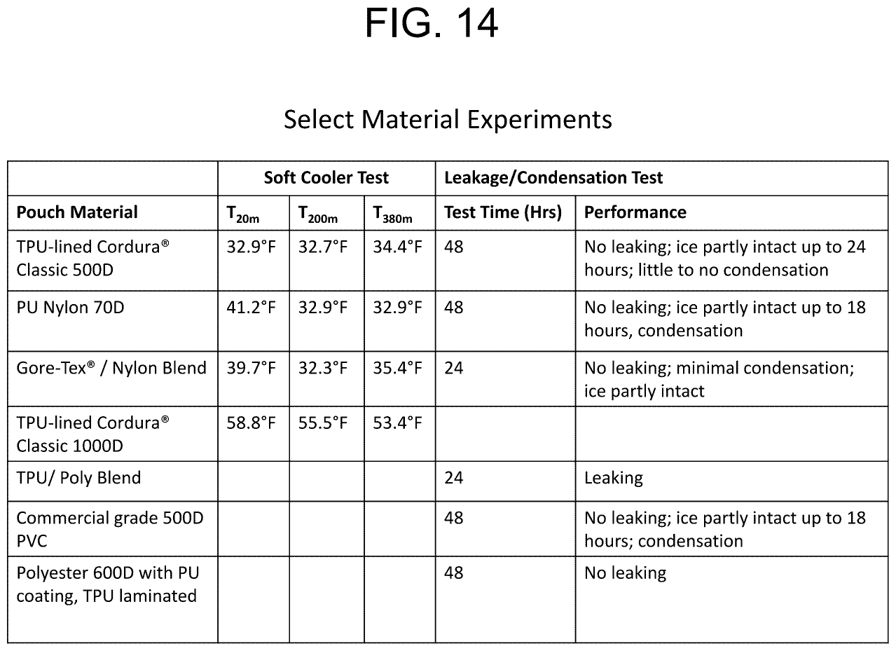

Additionally, because the pouch is designed to emit the cold from the ice without leaving a mess from the ice, certain macro level properties may be present with the pouch in example embodiments. For example, having a temperature conductivity from the inside of the pouch to the outside of the pouch whereby the ice inside the pouch can cool quickly and for an extended period the external environment to freezing or just above freezing temperatures (approximately 32 to 39 degrees Fahrenheit). This is in contrast to the Yeti-style soft cooler bags and others that are designed to be insulative. Such bags would retain internal temperatures of approximately 40 degrees Fahrenheit, rather than emit cold to cool the surrounding environment. In FIG. 14, selected candidate materials undergo a soft cooler test which involves placing a pouch filled with 8-10 lbs of ice inside of a Whole Foods® grocery store purchased but unlabeled soft cooler [13 inches length×12 inches width and 7 inches depth, polyester exterior, polyethylene insulation and polyethylene vinyl acetate lining] that is around the size of a typical paper grocery bag in the US market. The filled pouch is sealed and placed directly into the soft cooler and the soft cooler is then sealed. After 20 minutes, the soft cooler is opened and then the temperature in the soft cooler interior is measured and reproduced in FIG. 14 where shown. (Empty spaces in FIG. 14 have not undergone the same testing.) Three hours later, the temperature is tested again. And then three hours after that, the temperature is tested for the last time. The results are shown in FIG. 14. It should be stated that inclusion in FIG. 14 as a potential material for the pouch with positive test results does not imply that the material is workable for the pouch. For a variety of reasons not listed in this chart, such as lack of flexibility, some materials may not be great candidates. In the soft cooler test, it is desirable for the temperature in the cooler to quickly absorb the cold from the ice-filled pouch at the initial temperature reading and continue to stay cold over time. Cordura®® 500D had the best results in that it came down the temperature quickly and stayed at an ideal temperature for the entire period of the soft cooler test.

Additionally, in FIG. 14, leakage and condensation testing are shown of a pouch filled with ice and sealed [AND PLACED IN A SEALED COOLER??] after 48 hours. If the leakage testing failed after 24 hours, then testing was stopped. Several materials passed the leakage test but still had some amount of condensation. Some amount of condensation such as in the Gore-Tex® fabric/nylon blend may be acceptable depending on the application but other materials like PVC had an unacceptable amount of condensation.

From the chart in FIG. 14, we can see that Cordura® 500D (D=Denier) and Cordura® 1000D, when lined with TPU, have drastically different results. The Cordura® 1000D had unacceptable temperature conductivity while the Cordura® 500D had acceptable temperature conductivity. Therefore, similar materials relatively speaking can have unexpectedly different results. In addition, Cordura® 1000D is not as flexible making it less ideal material. In addition we see that Gore-Tex® fabric/nylon blend has better results in the soft cooler test than Cordura® 1000D and minimal condensation. While TPU Nylon 70D had decent soft cooler test leakage test results, it suffered from condensation on the exterior of the pouch. FIG. 14 illustrates some example candidate materials but is by no means a complete selection of materials that are suitable for the example embodiments.

Once given the above disclosure, many features, modifications, and improvements will become apparent to the skilled artisan. Such other features, modifications, and improvements are therefore considered to be a part of this invention, the scope of which is to be determined by the following processes. The features, functions, configurations, and orientations of pouch and pouch system elements described herein, along with other aspects of the present invention will become apparent upon reading the detailed description in conjunction with the associated drawings. Other features and advantages of the invention will be apparent from the following description, the figures, and from the claims presented, according to the present invention. While the aforementioned is a completed description of the embodiment of the invention, it should be evident that various modifications, alterations, alternatives, and equivalents may be made and used, Accordingly, the above description should not be taken as limiting the scope of the invention, which is defined by the metes and bounds of the appended claims.

Unless otherwise defined, all technical and scientific terms used herein have the same meaning as commonly understood by one of ordinary skill in the art to which the claimed features belong. Moreover, Applicant's inconsistent use of a term should not be construed as different terms unless defined by Applicant or the context. Although methods and materials similar to or equivalent to those described herein can be used in the manufacturing and use of the example embodiments, suitable methods and materials are described above. The example embodiments may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Other objects and advantages of the various embodiments of the example embodiments will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

There has thus been outlined, rather broadly, some of the features of the pouch, pouch system and methods of manufacturing and using herein in order that the detailed description thereof may be better understood, and in order that the present contribution to the art may be better appreciated.

It will be apparent to those skilled in the art that various modifications and variations can be made to the disclosed pouch, systems, materials, constructions, methods, and components herein. Other embodiments will be apparent to those skilled in the art from consideration of the specification and practice of the disclosed inventions. Numerous modifications, changes, variations, substitutions, and equivalents will occur to those skilled in the art without departing from the spirit and scope of claimed invention. It is intended that the specification and examples be considered as exemplary only, with a true scope being indicated by the claims, as later amended, and their equivalents. The benefits, advantages, solutions to problems, and any element(s) that may cause any benefit, advantage, or solution to occur or become more pronounced are not to be construed as a critical, required, or essential features or elements of any or all the claim, unless asserted as such by Applicant's remarks in the record. Accordingly, the specification and figures are to be regarded in an illustrative rather than a restrictive sense, and all such modifications are intended to be included within the scope of the claimed invention. Likewise, it is to be understood that the phraseology and terminology employed herein are for the purpose of the description and should not be regarded as limiting.

Regarding additional interpretation and construction of terms and steps herein, method steps are not in any specified order unless dictated by the context or specific wording. In addition, a use of a word in the singular form should be interpreted where the context allows, or does not restrict, so as to enable plurality or an “at least one” construction. Positional and directional terms described in this specification may be understood to be different than shown or described, and should not limit the variations of embodiments possible from the claimed features that a person of ordinary skill in the art would understand from the specification, figures and claims. The term “and/or” in a list means all list items present, some list items present, or one of the list items present, unless such construction is limited by the context. The term “including” means “including, but not limited to.”

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

1-16. (canceled)

17. An ice pouch cooler system, the system comprising:
a pouch with at least two layers configured to allow temperature conduction from an ice reservoir surrounded by a waterproof layer through a pouch exterior including a moisture wicking layer to the atmosphere surrounding the pouch; and
a cooler with an insulating exterior configured includes a reservoir and an insulated exterior,
wherein the at least two layers of the pouch are chosen to have the temperature conduction configured to bring an internal temperature of the cooler from room temperature to between 30-40 degrees Fahrenheit within less than half an hour from a time of inserting the pouch whose ice reservoir is filled with ice and placed into the cooler reservoir and sealing the cooler.

18. The ice patch cooler system of claim 17, wherein the pouch is filled with 10-25 lbs. of ice or meltwater therefrom.

19. The method of manufacturing a pouch, the method comprising the steps of:
waterproof sealing a water-resistant fabric together to define an ice reservoir between the fabric;
creating a resealable opening conduit to the ice reservoir that includes a portion of the opening conduit that has a width larger than a width of the ice reservoir;
coupling the fabric together across the ice reservoir to define a channel edge that segments two adjacent areas of the ice reservoir; and
surrounding the fabric with a moisture-wicking layer.

20. The method of claim 19, wherein the water-resistant fabric is TPU and the moisture wicking layer is Cordura® Classic 500D.

21. The method of claim 19, further comprising the steps of
filling the ice reservoir with ice,
sealing the pouch; and
placing the pouch in a cooler.

22. The method of claim 19, wherein the step of creating the resealable opening conduit includes adding a funnel, support structure, or a self-actuating opening to the pouch to aid with filling the ice reservoir through the resealable opening conduit.

23. The method of claim 22, wherein the self-actuating opening comprises at least one of steel bistable spring bands or nitinol shape memory alloy.

23. The method of claim 22, wherein the funnel folds into the resealable opening conduit or leaves the resealable opening conduit and remains connected to the exterior of the pouch when not operable for filling the ice reservoir and does not affect sealing.

24. The method of claim 21, wherein the pouch is flexible enough to take the shape of the interior of the cooler.

25. The ice patch cooler system of claim 17, wherein one layer is a cold store that absorbs the cold from within the ice reservoir and transmits the cold over an extended period of time.

26. The ice patch cooler system of claim 25, wherein the cold store includes at least one of a non-toxic bead, clay or gel.

27. The ice patch cooler system of claim 17, wherein the at least two layers is a blended material.

28. The ice patch cooler system of claim 27, wherein the blended material is Gore-tex®/Nylon blend with a waterproof lining.

29. The ice patch cooler system of claim 17, the moisture wicking layer is a flocked material or another material that disperses moisture.
